(19) United States
(12) Patent Application Publication
(10) Pub. No.: US 2009/0017695 A1
(43) Pub. Date: Jan. 15, 2009

(54) Electrical connector assembly

(75) Inventors: Jia-Yong He, Kunshan (CN); Qi-Sheng Zheng, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/217,189

(22) Filed: Jul. 1, 2008

(30) Foreign Application Priority Data
Jul. 10, 2007 (CN) 200720040642.X

(51) Int. Cl. H01R 24/00

(52) U.S. Cl. 439/676

(57) ABSTRACT

An electrical connector assembly (100) combining at least two different types of interfaces, includes a first housing (1) having a first mating portion (11) at a front surface and a protrusion (12) extending from a bottom surface thereof. The protrusion has an upper portion and a lower portion being wider than the upper portion. A set of first terminals (3) are mounted on the first housing and extend into the first mating portion thereof. A second housing (2) is assembled to the first housing. The second housing has a second mating portion (21) at a front surface and a recess (26) at a top surface thereof to retain the protrusion therein. The recess has an upper portion and a lower portion being wider than the upper portion. A plurality of second terminals (4) are mounted on the second housing and extend into the second mating portion thereof. A second inner shell (6) encloses the second mating portion of the second housing. The second inner shell has a top surface abutted against by the protrusion.

### BACKGROUND OF THE INVENTION

1. Field of the Invention

The present invention generally relates to an electrical connector assembly and more particularly to an electrical connector assembly having different types of interfaces.

2. Description of Related Art

A conventional electrical connector assembly having different types of interfaces, comprises an insulative housing having a first mating portion for mating with a USB plug connector and a second housing having a second mating portion for mating with a SATA plug connector. A plurality of first terminals received in the first mating portion. A plurality of second terminals received in the second mating portion. The first mating portion and the second mating portion which have different types of interfaces integrally formed on the insulative housing will complicates the manufacturing process and increase the manufacturing costs. Furthermore, the insulative housing is a one-piece structure unitarily molded of dielectric material such as plastic or the like, the first mating portion and the second mating portion which look like the same color could not be identified easily, and it possible to mismate the plugs with the interfaces.

Hence, an improvement over the prior art is required to overcome the problems thereof.

### SUMMARY OF THE INVENTION

According to one aspect of the present invention, an electrical connector assembly combining at least two different types of interfaces comprises a first housing having a first mating portion at a front surface and a protrusion extending from a bottom surface thereof. The protrusion has an upper portion and a lower portion wider than the upper portion. A plurality of first terminals are mounted on the first housing and extend into the first mating portion thereof. A second housing is assembled to the first housing. The second housing has a second mating portion at a front surface and a recess at a top surface thereof to retain the protrusion therein. The recess has an upper portion and a lower portion wider than the upper portion. A plurality of second terminals are mounted on the second housing and extend into the second mating portion thereof. A second inner shell encloses the second mating portion of the second housing. The second inner shell has a top surface abutted against by the protrusion.

According to another aspect of the present invention, an electrical connector assembly comprises a first housing having a pair of first mating portions for mating with USB plug connectors and a protrusion extending from a bottom surface thereof. The protrusion has an upper portion and a lower portion wider than the upper portion. A plurality of first terminals are mounted on said first housing and extend into the first mating portion thereof. A second housing assembled to the first housing. The second housing has a second mating portion for mating with a SATA plug connector and a pair of retaining posts extending from a top surface thereof. The retaining posts engage with opposite sides of the protrusion and have an upper portion and a lower portion narrower than the upper portion. A plurality of second terminals are mounted on the second housing and extend into the second mating portion thereof. A second inner shell encloses the second mating portion of the second housing. The second inner shell has a top surface abutted against by the protrusion.

These and additional objects, features, and advantages of the present invention will become apparent after reading the following detailed description of the preferred embodiment of the invention taken in conjunction with the appended drawings.

### BRIEF DESCRIPTION OF THE DRAWINGS

FIG. 1 is a front perspective view of an electrical connector assembly in accordance with the present invention;

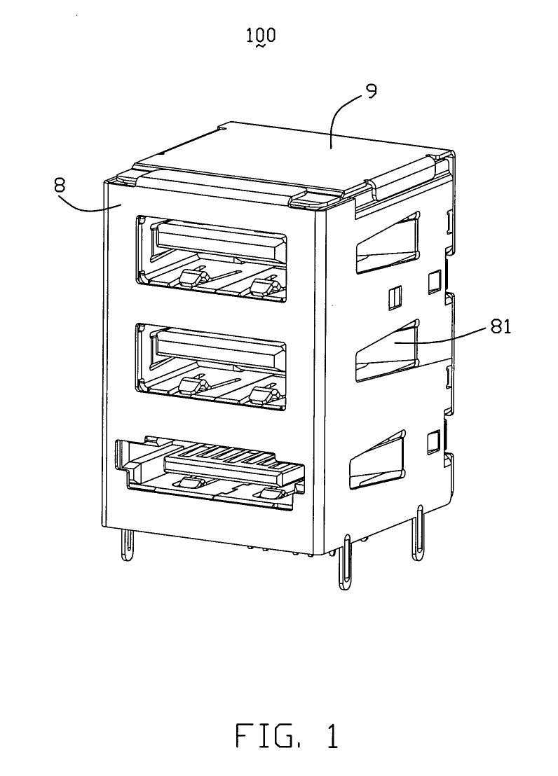

FIG. 2 is a front partially exploded view of the electrical connector assembly shown in FIG. 1;

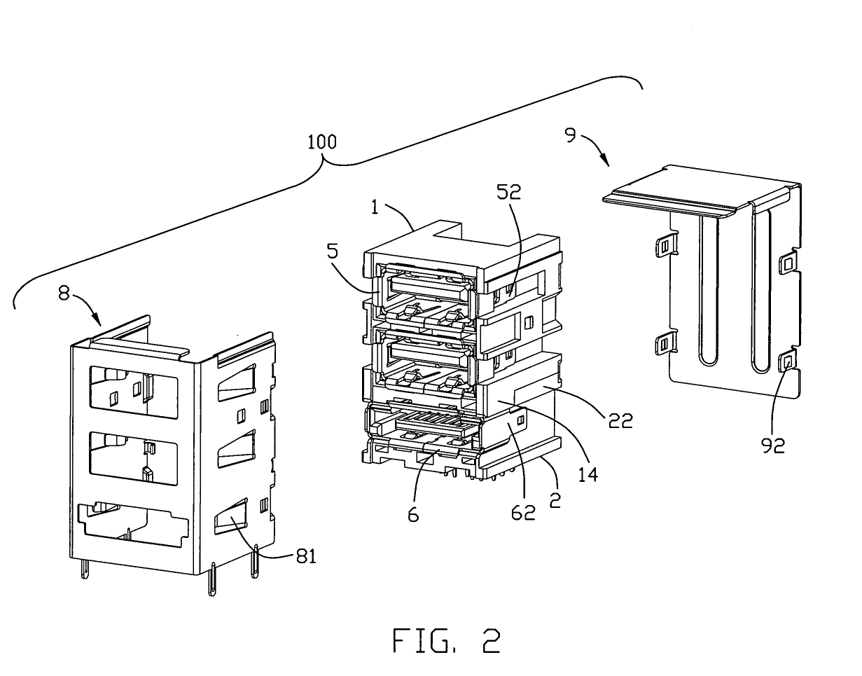

FIG. 3 is a rear perspective view of the electrical connector assembly with the rear shell removed shown in FIG. 1;

FIG. 4 is a front exploded view of the electrical connector assembly shown in FIG. 1;

FIG. 5 is a rear exploded view of the electrical connector assembly shown in FIG. 1;

FIG. 6 is an enlarged view of the first and second housing shown in FIG. 1; and

FIG. 7 is a rear elevational view of the electrical connector assembly without the outer shell and the rear shell shown in FIG. 1.

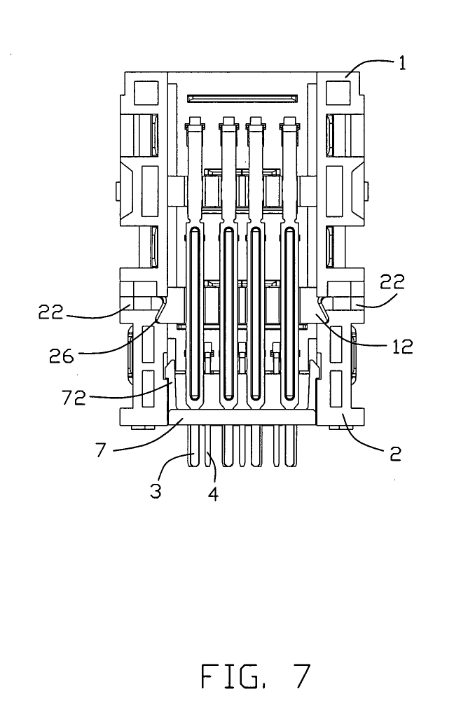

### DETAILED DESCRIPTION OF THE INVENTION

Reference will now be made to the drawing figures to describe the preferred embodiment of the present invention in detail.

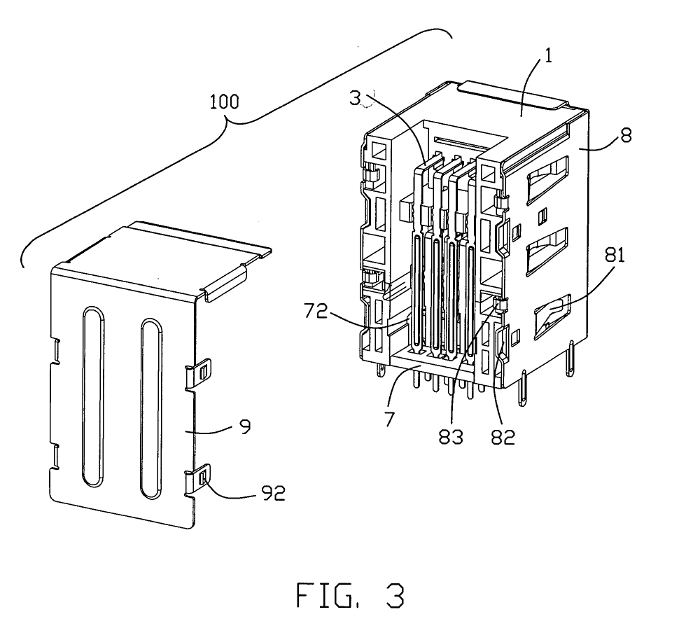

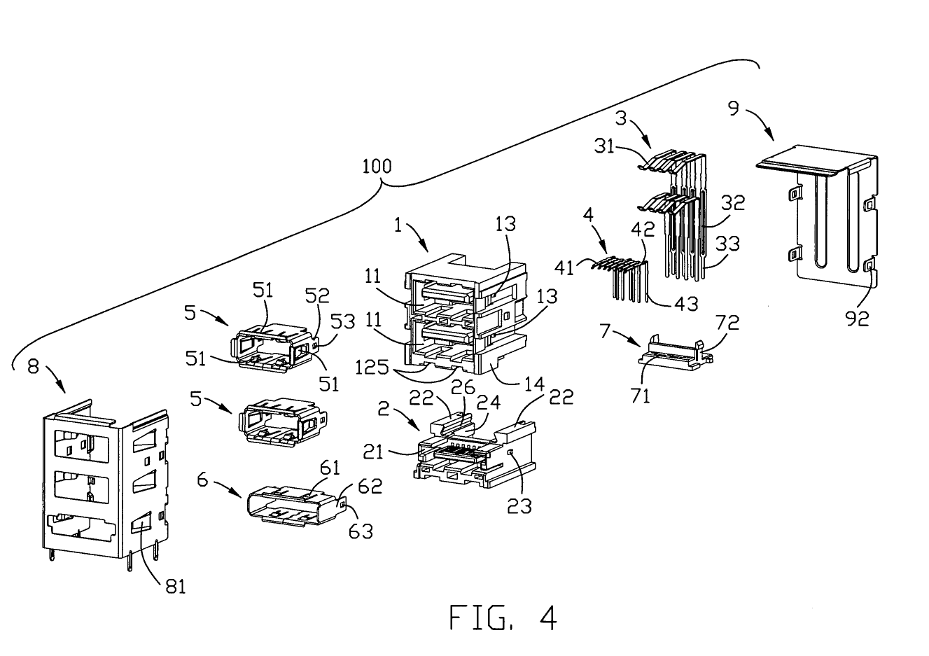

Referring to FIGS. 3 and 4, the electrical connector assembly 100 according to the present invention, comprises a first housing 1, a plurality of first terminals 3 mounted on the first housing 1, a second housing 2 assembled to the first housing 1, a plurality of second terminals 4 mounted on the second housing 2, a pair of first inner shells 5 coupled to the first housing 1, a second inner shell 6 coupled to the second housing 2, a spacer 7 coupled to the second housing 2, an outer shell 8 enclosing the first housing 1 and the second housing 2, and a rear shell 9 coupled to the outer shell 8.

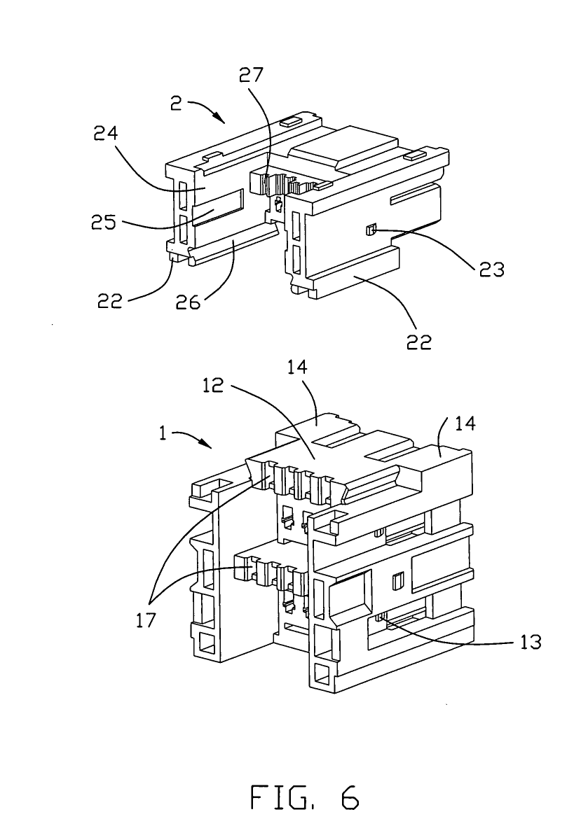

Referring to FIGS. 4-6, the first housing 1 defines a pair of first mating portions 11 both for mating with USB (Universal Serial Bus) plug connectors (not shown). The first housing 1 has a receiving space 15 in a rear end and a plurality of first retaining slots 17 communicating with the receiving space 15, a dove-tail protrusion 12 extending from a bottom surface thereof and a pair of first locking projections 13 formed on opposite sides thereof. The protrusion 12 has an upper portion and a lower portion wider than the upper portion. The protrusion 12 has a pair of stopping portions 14 forwardly at opposite sides thereof to limit a forward movement of the second housing 2 and a pair of grooves 125 in a bottom surface thereof. The second housing 2 defines a second mating portion 21 for mating with a SATA (Serial ATA) plug connector (not shown). The second housing 2 has a pair of second locking projections 23 at opposite sides thereof and a receiving chamber 24 in a rear end thereof. A pair of notches 25 are defined at opposite side walls of the receiving chamber 24. The second housing 2 has a plurality of second retaining slots 27 rearwardly and communicating with the receiving chamber 24. The second housing 2 has a pair of retaining posts 22 having a upper portion and a lower portion being narrower than the upper portion and extending from a top surface thereof. A dove-tail recess 26 is formed between the retaining posts 22 to retain the protrusion 12 therein and communicates with the receiving chamber 24. Thereby the recess 26 has an upper portion and a lower portion wider than the upper portion. The first housing 1 can be coupled to the second housing 2 reliably via the locking engagement between the protrusion 12 and the recess 26. The stopping portions 14 abutting against the front end of the retaining posts 22 to limit a forward movement of the second housing 2. The recess 26 communicates with the receiving space 15. The first housing 1 and the second housing 2 which have two different types of interfaces could be different in color so as to be identified easily and could be manufactured respectively so as to be molded easily.

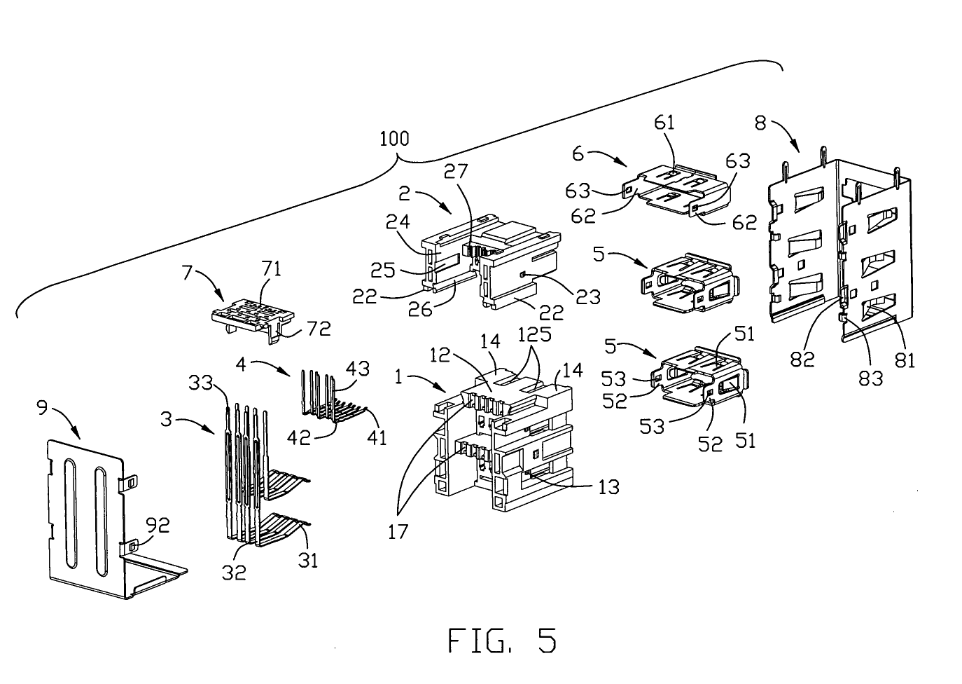

Referring to FIGS. 4 and 5, each first terminal 3 includes a first contacting portion 31 for engaging with an appropriate terminal of the USB plug connector, a first tail portion 33 for electrical connection to an appropriate circuit trace on a printed circuit board (not shown), and a first jointing portion 32 connecting the first contacting portion 31 and the first tail portion 33. The first contacting portion 31 extends into the first mating portion 11. The first jointing portion 32 extends downwardly from the first contacting portion 31 to be retained in the appropriate first retaining slot 17 and go through the receiving space 15 of the first housing 1.

Each second terminal 4 includes a second contacting portion 41 for engaging with an appropriate terminal of the SATA plug connector, a second tail portion 43 for electrical connection to an appropriate circuit trace on the printed circuit board, and a second jointing portion 42 connecting the second contacting portion 41 and the second tail portion 43. The second jointing portion 42 extends downwardly from the second contacting portion 41 to be retained in the appropriate second slot 27 of the second housing 2.

The first inner shells 5 are received in the first mating portions 11. Each first inner shell 5 has a plurality of first fingers 51 formed at a top surface, a bottom surface and opposite sides thereof for engaging with an appropriate shell of the complementary USB plug connector. Each first inner shell 5 has a pair of first legs 52 projecting rearwardly thereof and coupled to opposite outsides of the first housing 1. The first legs 52 have a pair of first perforations 53 for engaging with the first locking projections 13.

The second inner shell 6 encloses the second mating portion 21 of the second housing 2. The protrusion 12 of the first housing 1 abuts against a top surface of the second inner shell 6 to prevent the second inner shell 6 from deformation. The second inner shell 6 has a pair of second fingers 61 formed at the top surface and received in the grooves 125 of the protrusion 12 and a pair of second fingers 61 formed at a bottom surface thereof. The second inner shell 6 has a pair of second legs 62 projecting rearwardly thereof and coupled to opposite outsides of the second housing 2. The second legs 62 have a pair of second perforations 63 for engaging with the second locking projections 23.

The spacer 7 is received in the receiving chamber 24 and has a plurality of holes 71 for retaining the first terminals 3 and the second terminals 4. The spacer 7 has a pair of bulking arms 72 for engaging with the notches 25.

The outer shell 8 has a plurality of contacting tabs 81 bent inwardly for electrically contacting the first legs 52 and the second legs 62 so as to eliminate the static electricity on the first shell 5 and the second shell 6. The outer shell 8 has a plurality of apertures 82 and latching barbs 83 at a rear end thereof. The latching barbs 83 are bent inwardly to latch the first housing 1 and the second housing 2. The rear shell 9 has a plurality of latching tabs 92 for engaging with the apertures 82.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector assembly combining at least two different types of interfaces, comprising:
a first housing having a first mating portion at a front surface and a protrusion extending from a bottom surface thereof, the protrusion having an upper portion and a lower portion being wider than the upper portion;
a plurality of first terminals mounted on said first housing and extending into the first mating portion thereof;
a second housing assembled to the first housing, the second housing having a second mating portion at a front surface and a recess at a top surface thereof to retain the protrusion therein, the recess having an upper portion and a lower portion being wider than the upper portion;
a plurality of second terminals mounted on said second housing and extending into the second mating portion thereof; and
a second inner shell enclosing the second mating portion of the second housing, the second inner shell having a top surface being abutted against by the protrusion.

2. The electrical connector assembly as claimed in claim 1, wherein the protrusion has a pair of stopping portions being adjacent to the front surface to limit a forward movement of the second housing.

3. The electrical connector assembly as claimed in claim 1, wherein the second inner shell has a pair of second fingers at the top surface, the protrusion has a pair of grooves to receive the fingers.

4. The electrical connector assembly as claimed in claim 1, wherein the electrical connector assembly comprises a first inner shell received in the first mating portion thereof, the first inner shell has a pair of first legs rearwardly extending from opposite sides thereof and coupled to opposite outsides of the first housing.

5. The electrical connector assembly as claimed in claim 4, wherein the second inner shell has a pair of second legs rearwardly extending from opposite sides thereof and coupled to opposite outsides of the second housing.

6. The electrical connector assembly as claimed in claim 5, wherein the electrical connector has an outer shell enclosing the first and second housing, the outer shell has a plurality of contacting tabs at opposite sides thereof to contact the corresponding first and second legs.

7. The electrical connector assembly as claimed in claim 6, wherein the outer shell has a plurality of latching barbs to latch the first and second housing.

8. The electrical connector assembly as claimed in claim 1, wherein the electrical connector assembly has a spacer coupled to the second housing, the spacer has a plurality of holes for retaining the first and the second terminals.

9. The electrical connector assembly as claimed in claim 8, wherein the second housing has a receiving chamber to receive the spacer and communicating with the recess.

10. The electrical connector assembly as claimed in claim 9, wherein the first housing has a plurality of first retaining slots for retaining the first terminals and a receiving space for the first terminals going through, the receiving space communicates with the recess of the second housing.

11. An electrical connector assembly, comprising:
a first housing having a pair of first mating portions for mating with USB plug connectors and a protrusion extending from a bottom surface thereof, the protrusion having an upper portion and a lower portion wider than the upper portion;
a plurality of first terminals mounted on said first housing and extending into the first mating portion thereof;
a second housing assembled to the first housing, the second housing having a second mating portion for mating with SATA plug connector and a pair of retaining posts extending from a top surface thereof, the retaining posts engaged with opposite sides of the protrusion and having an upper portion and a lower portion narrower than the upper portion;
a plurality of second terminals mounted on said second housing and extending into the second mating portion thereof; and
a second inner shell enclosing the second mating portion of the second housing, the second inner shell having a top surface abutted against by the protrusion.

12. The electrical connector assembly as claimed in claim 11, wherein the protrusion has a pair of stopping portions abutting against the retaining posts to limit a forward movement of the second housing.

13. The electrical connector assembly as claimed in claim 11, wherein the second inner shell has a pair of fingers at the top surface, the protrusion has a pair of grooves to receive the fingers.

14. The electrical connector assembly as claimed in claim 11, wherein the electrical connector assembly comprises a pair of first inner shells received in the first mating portions thereof, each first inner shell has a pair of first legs rearwardly extending from opposite sides thereof and coupled to opposite outsides of the first housing.

15. The electrical connector assembly as claimed in claim 14, wherein the second inner shell has a pair of second legs rearwardly extending from opposite sides thereof and coupled to opposite outsides of the second housing.

16. The electrical connector assembly as claimed in claim 15, wherein the electrical connector has an outer shell enclosing the first and the second housing, the outer shell has a plurality of contacting tabs at opposite sides thereof to contact the corresponding first and second legs.

17. An electrical connector assembly comprising:
an upper insulative housing defining an upper mating port with a plurality of upper contacts extending thereinto;
a protrusion formed on a bottom portion of the upper housing and defining a plurality of contact retention channels in a rear face thereof to receive the corresponding upper contacts, respectively;
a lower insulative housing defining a lower mating port with a plurality of lower contacts extending thereinto;
a recessed portion being formed in a top portion of the lower housing and snugly interengaged with the protrusion in both a vertical direction and a transverse direction perpendicular to said vertical direction so as to retainably stacked the upper housing to the lower housing.

18. The electrical connector assembly as claimed in claim 17, wherein said upper housing further includes a stopper portion coplanar with the protrusion and engaged with the recessed portion in a front-to-back direction for preventing relative movement of the upper housing and the lower housing in said front-to-back direction.
